(19) United States
(12) Patent Application Publication
(10) Pub. No.: US 2002/0098828 A1
(43) Pub. Date: Jul. 25, 2002

(54) Per-call based prepaid service accessed through a non-prepaid subscription mobile station

(76) Inventors: Georges Wakil, Cairo (EG); Richard Brunner, Bromma (SE)

Correspondence Address: ERICSSON RESEARCH CANADA, 8400 DECARIE BLVD., MONTREAL, QC, H4P 2N2, CA

(21) Appl. No.: 09/770,217

(22) Filed: Jan. 25, 2001

(51) Int. Cl. H04M 11/00

(52) U.S. Cl. 455/408; 455/406

(57) ABSTRACT

A non-prepaid subscription cellular mobile station operates to provide for communications over a selected wireless cellular air interface. A call is established over the air interface to allow the serving network to collect calling information relating to a mobile station user's prepaid call request. This information is processed in the cellular network to determine whether the user is financially authorized for the established call to engage in the requested prepaid call. If so, call handling information relating to an authorized time duration for the call is supplied to a serving switch that then controls further handling, and if necessary termination, of that call in accordance with that information. In this way, charging for the call is advantageously applied on a per-call basis against the user's prepaid account instead of the mobile station's non-prepaid subscription.

### BACKGROUND OF THE INVENTION

1. Technical Field of the Invention

The present invention relates to wireless telecommunication payment solutions and, in particular, to a system and method for providing prepaid service to a user on a per-call basis through a non-prepaid subscription mobile station.

2. Description of Related Art

Prepaid wireless service plans are becoming more and more popular with consumers. With such plans, the consumer has access to wireless telephone service but is not saddled with a long term contract or a minimum monthly charge. Instead, the consumer pays a fixed amount in advance to purchase calling credits. As the consumer makes and/or receives calls, debits are made to the purchased calling credits. When the credits run out, the consumer contacts the wireless service provider and buys additional credits to continue service. The systems and methods which support this kind of service plan provision are well known to those skilled in the art.

There exist instances where consumers having conventional, non-prepaid service plans (subscriptions) would like to have access to prepaid services on an individual call-by-call basis. For example, consider the situation where a non-prepaid subscriber lets a friend borrow his cellular mobile station to make a call. In many situations, the subscriber may not be concerned with cost issues for this call. However, if the call is long distance or if the subscriber is currently roaming, the cost of the friend's call may become a significant concern. Consider also another situation where the cellular subscription for the mobile station is owned by a business but the using employee desires to make a personal call. There may exist employer rules prohibiting use of the business wireless subscription for personal calls.

In each of the foregoing scenarios, a need exists to allow the user of the mobile station to access the cellular network to make a call with the cost of that call being charged on a prepaid basis to the user instead of being charged against the non-prepaid cellular mobile station subscription. The present invention addresses this need by providing prepaid service to a user on a per-call basis through a non-prepaid subscription mobile station.

### SUMMARY OF THE INVENTION

A mobile station is operable to communicate over a selected one or ones of the wireless cellular air interfaces (like D-AMPS, GSM, PCS or CDMA) and possesses a conventional non-prepaid subscription. A conventional cellular network infrastructure is provided to support that non-prepaid subscription and is further augmented by a prepaid service system adapted to support per-call based prepaid charging with respect to mobile station use. The prepaid service system operates to collect, through the cellular network, calling information relating to a call request made from the mobile station for prepaid service, determine whether the caller is financially authorized to engage in the requested call, and supply information used by a serving switch to control handling of that call in accordance with the determined financial authorization. In this way, charging for the call is advantageously applied against the user's prepaid account instead of the mobile station's non-prepaid subscription.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 is a network diagram for the wireless system of the present invention; and

FIG. 2 is a signal flow and network operation diagram illustrating the provision of per-call based prepaid service accessed through a non-prepaid subscription mobile station.

### DETAILED DESCRIPTION OF THE DRAWINGS

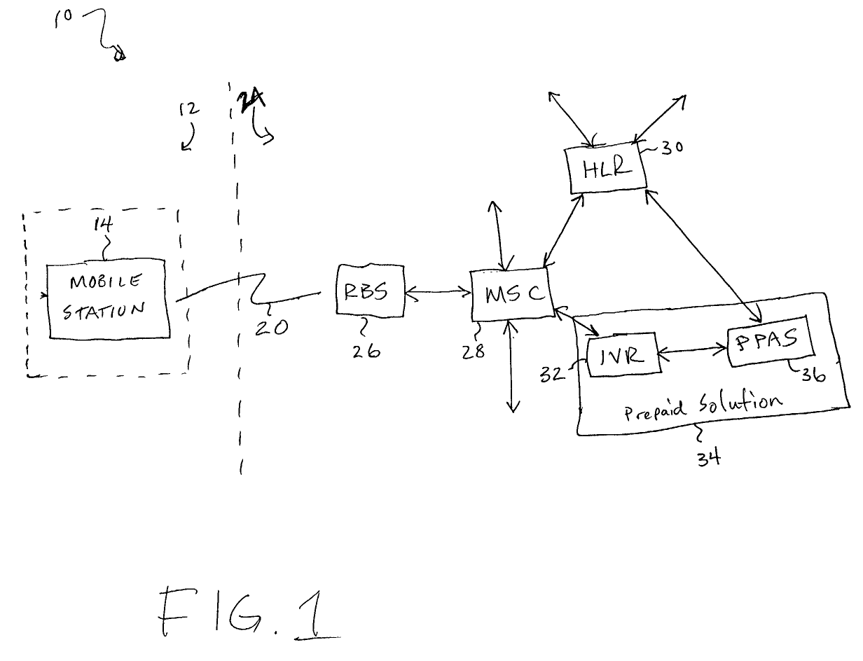

Reference is now made to FIG. 1 wherein there is shown a network diagram for the wireless system 10 of the present invention. The system includes, on a user side 12, a wireless cellular terminal 14 operable to access for wireless calling service a selected one or ones of the wireless cellular air interfaces (like D-AMPS, GSM, PCS or CDMA) 20. On a network side 24 of the system 10, a radio base station (RBS) 26 communicates with the cellular terminal 14 over the air interface 20. The base station 26 is connected in a well known manner to a mobile switching center 28 (only one of many is shown in order to simplify the drawing). The mobile switching center 28 is connected via ANSI-41 (or any other network signaling standard) signaling links to a home location register (HLR) 30. This collection of network components operates in a well known manner to provide wireless cellular voice and data calling services to non-prepaid subscribers. Accordingly, a more detailed description of network operation is provided herein only with respect to the operation of the present invention for accessing per-call based prepaid services through a non-prepaid subscription mobile station.

The mobile switching center 28 is further connected via ISUP trunks to an interactive voice response (IVR) center 32. The interactive voice response center 32 comprises one component of a wireless prepaid solution (PPS) system 34 manufactured and supplied by Ericsson. The system 34 further includes a pre-paid administration system (PPAS) node 36 that is connected via a TCP/IP connection to the interactive voice response center 32, and via ANSI-41 (or any other network signaling standard) signaling links to the home location register 30. Operation of the prepaid solution system to provide prepaid wireless cellular voice and data calling services to subscribers is well known to those skilled in the art. Accordingly, a more detailed description of prepaid solution system operation is provided herein only with respect to the operation of the present invention for accessing per-call based prepaid services through a non-prepaid subscription mobile station.

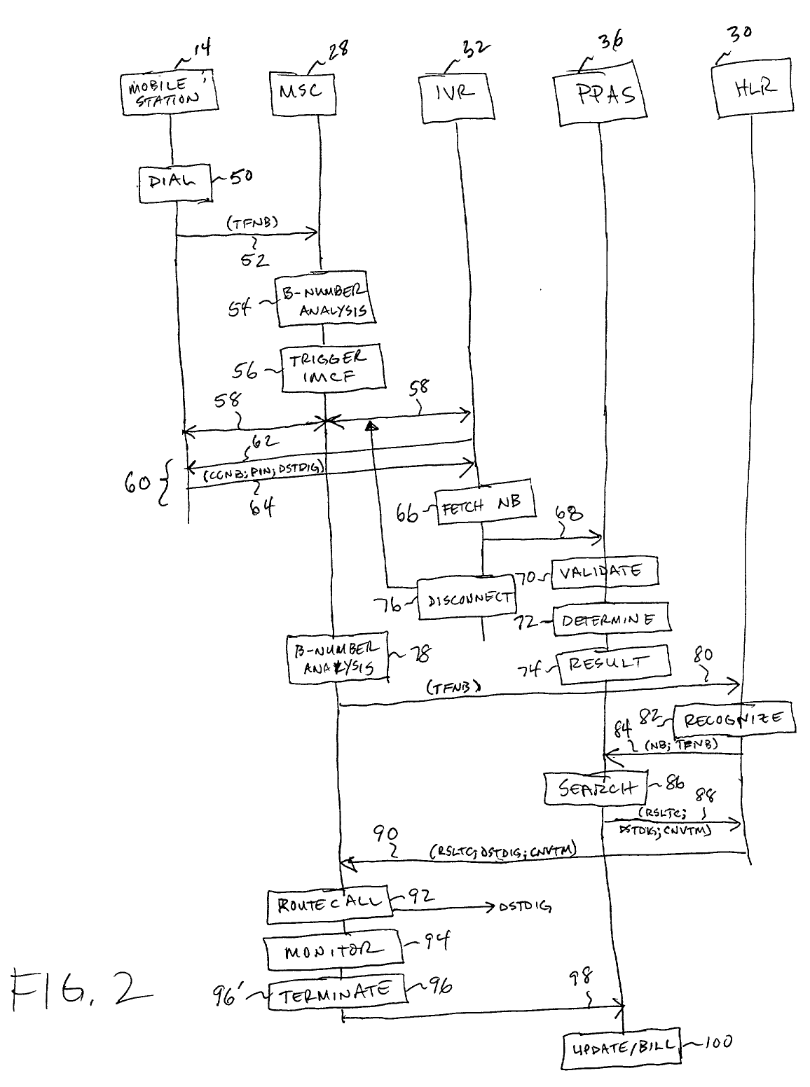

Reference is now additionally made to FIG. 2 wherein there is shown a signal flow and network operation diagram illustrating the provision of per-call based prepaid services through a non-prepaid subscription in the context of the FIG. 1 system. The cellular terminal (mobile station) 14 is defined within the home location register 30 as a normal (i.e., non-prepaid or post-paid subscription) cellular subscriber. In this regard, it has a defined subscription and an assigned telephone number (NB). The home location register 30 is further programmed with the identification of a toll free number (TFNB) which identifies a generic prepaid subscriber (i.e., a cellular prepaid subscription) with a special prepaid category indicating that the TFNB is to be used for per-call based prepaid services that would allow a caller (user) to prepay for an individual call instead of having the charge for that call be assessed against the post-pay cellular subscription of the mobile station.

Responsive to a user need to make a phone call that is not to be charged to the post-paid cellular subscription, the user dials the toll free number (step 50) from the mobile station 14, and the mobile station sends (step 52) the number over the air interface 20 towards the radio base station 26 and mobile switching center 28. In this step 52 operation, the TFNB comprises the called number digits as contained within a conventional wireless call origination message sent over the air interface 20. It should therefore be recognized that because the number is toll free, the mobile station post-paid cellular subscription is not charged for this outgoing call. It should also be noted that the user has not yet dialed the destination digits of the called party for the desired call.

The mobile switching center 28 performs conventional B-number analysis (step 54) on the called number digits that were sent in step 52. The mobile switching center 28 is programmed with the TFNB in its B-number analysis table to trigger (step 56) execution of an incoming message coordination feature (IMCF) which, generally speaking, causes an announcement to be played to the user before the mobile switching center 28 completes the B-number analysis and pre-routes to the called number (i.e., to the TFNB). The mobile station 14 is accordingly voice channel connected (step 58), with respect to provision of the incoming message coordination feature, to the interactive voice response center 32 over the air interface 20 and through the radio base station 26 and mobile switching center 28.

The interactive voice response center 32 then engages in an interactive transaction (step 60) where the user of the mobile station 14 is voice message prompted (steps 62) to enter (steps 64) a credit or calling card number (CCNB), personal identification number (PIN) code, and destination digits (DSTDIG) for the desired outgoing call. The interactive voice response center 32 further fetches (step 66) from the ISUP trunks carrying the call connection the identification of the calling party (which in this case is the mobile station 14 number (NB)). The interactive voice response center 32 collected information (NB, CCNB, PIN and DSTDIG) is then forwarded (step 68) to the pre-paid administration system (PPAS) node 36 via the TCP/IP connection interface.

The pre-paid administration system node 36 then validates (step 70) the CCNB and PIN against each other and determines (step 72) a maximum conversation time (CNVTM) permitted for the user in accordance with that validation. This determined maximum conversation time may be based on a remaining balance with respect to an established prepaid telecommunications service account identified by the CCNB, protected by the PIN, and maintained with respect to that user. Alternatively, it may comprise a maximum time determined from a maximum pre-authorized credit card charge amount (which, in essence, becomes an established prepaid service balance for the current call). In any event, the determination in step 72 takes into account conventional charging factors that affect charging rate determination including time of day and distance (based on the collected DSTDIG information). A result code (RSLTC) is then generated (step 74) based on that step 72 determination, wherein the code indicates whether the pre-paid administration system node 36 has authorized continuing with call setup from the mobile station 14 number (NB) to a certain destination (DSTDIG) for a certain amount of time (CNVTM).

In the meantime, the interactive voice response center 32 has completed its business with the user and disconnects (step 76) itself from the call. This occurrence is detected by the mobile switching center 28 which responds by triggering continuation of incoming message coordination feature execution. Continued B-number analysis of the dialed TFNB is performed (step 78) causing the mobile switching center 28 to contact (step 80) the home location register 30 associated with the TFNB (using, for example, a location request message (LOCREQ), or the like, containing the dialed TFNB) to pre-route the call origination. The home location register 30 recognizes (step 82) that the TFNB is defined as a special prepaid subscriber (i.e., it is not the called party number) and accordingly queries (step 84) the pre-paid administration system node 36 with the calling party number (NB) for the mobile station 14 and the dialed number (TFNB) in a special query message relating to per-call based prepaid service. A proprietary extension to the ANSI-41 (or any other network signaling standard) specification may be implemented to support operation of the present invention with respect to the message communications sent in steps 80 and 84.

The pre-paid administration system node 36 receives the home location register query and searches (step 86) its records to determine whether it has previously generated a result code (RSLTC) with respect to the query identified mobile station 14 number (NB) (see, steps 72 and 74 as discussed above). Assuming that such a result code was generated, and further that the result code indicates that the pre-paid administration system node 36 has authorized continuing with call setup, the determined result code (RSLTC), destination digits for the call (DSTDIG for the called party) and the authorized conversation time (CNVTM) information are returned (step 88) to the home location register 30 in a query return result message. This information is then passed on (step 90) to the mobile switching center 28 (using, for example, a location request return result message (locreq), or the like, containing the RSLTC, DSTDIG and CNVTM information). Again, a proprietary extension to the ANSI-41 (or any other network signaling standard) specification may be implemented to support operation of the present invention with respect to the message communications sent in steps 88 and 90.

Using the received destination digit information, the mobile switching center routes/through connects (step 92) the originated call to the user specified destination. Elapsed conversation time for the through connected call is monitored (step 94) in comparison to the maximum conversation time (CNVTM) permitted for the user. If the elapsed call time exceeds the specified maximum time, the call is terminated in step 96. If, on the other hand, the call is terminated (step 96′) by the user prior to expiration of the specified maximum time, the actual elapsed time for the call is sent (step 98) from the mobile switching center 28 to the pre-paid administration system node 36 through the home location register 30. The pre-paid administration system node 36 then updates stored prepaid balance (or arranges for billing, all generally step 100) with respect to the user and the completed call. What is important to recognize at this point is that the charge for this call is assessed against the prepaid account instead of against the mobile station post-paid subscription.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method, comprising the steps of:
responding to a received call origination dialed from a cellular mobile station having a post-paid subscription to a toll free telephone number recognized in a supporting cellular communications network as being associated with a prepaid subscription by triggering supporting cellular network calculation of a permitted prepaid use time for user communications effectuated through that mobile station;
through connecting the cellular mobile station to a user called destination to establish a call connection; and
monitoring a duration of the established call connection against the calculated permitted use time.

2. The method as in claim 1 further including the steps of:
detecting that the monitored duration has as least met the calculated permitted prepaid use time;
terminating the established call connection; and
charging a fee for the utilized permitted prepaid use time against a prepaid account instead of against the mobile station post-paid subscription.

3. The method as in claim 2 further including the steps of:
determining prior to the step of through connecting a method of payment for the call; and
applying the fee against the determined method of payment.

4. The method as in claim 1 further including the steps of:
detecting a user termination of the established call connection prior to the expiration of the permitted prepaid use time;
calculating an elapsed use time; and
charging a fee for the calculated elapsed use time against a prepaid account instead of against the mobile station post-paid subscription.

5. The method as in claim 4 further including the steps of:
determining prior to the step of through connecting a method of payment for the call; and
applying the fee against the determined method of payment.

6. A method, comprising the steps of:
receiving a call origination from a mobile station having a post-paid subscription, the call origination dialed to a first telephone number associated with a prepaid subscription;
triggering at a serving mobile switching center responsive to the received call origination and the dialed first telephone number the execution of an incoming message coordination feature;
collecting within the execution of the incoming message coordination feature a second telephone number identifying a called party and information concerning a prepaid method of payment for the call;
determining within a payment system of the supporting cellular network the calculation of a permitted use time for user communications effectuated through the mobile station and with the called party;
sending of a location request message including the first telephone number from the serving mobile switching center to a home location register that stores the prepaid subscription;
recognizing at the home location register that the location request message concerns a prepaid subscription and querying the payment system to retrieve the second telephone number and the permitted use time;
communicating the second telephone number and the permitted use time from the home location register to the serving mobile switching center;
through connecting the mobile station to the called party to establish a call connection; and
monitoring a duration of the established call connection against the calculated permitted use time.

7. The method as in claim 6 further including the steps of:
detecting that the monitored duration has as least met the calculated permitted use time;
terminating the established call connection; and
charging a fee for the utilized permitted use time.

8. The method as in claim 7 further including the step of applying the fee against the identified prepaid method of payment instead of against the post-paid subscription for the mobile station.

9. The method as in claim 6 further including the steps of:
detecting a user termination of the established call connection prior to the expiration of the permitted use time;
calculating an elapsed use time; and
charging a fee for the calculated elapsed use time.

10. The method as in claim 9 further including the step of applying the fee against the identified prepaid method of payment instead of against the post-paid subscription for the mobile station.

11. The method as in claim 6 wherein the first telephone number comprises a toll free number.

12. A wireless cellular system, comprising:
a mobile switching center receiving a call origination from a mobile station having a post-paid subscription, wherein the call origination is dialed to a first telephone number associated with a prepaid subscription, and triggering the execution of an incoming message coordination feature;
an interactive voice response system connected to the mobile switching center and activated by the incoming message coordination feature to collect from the mobile station a second telephone number identifying a called party and information concerning a prepaid method of payment for the call;
a payment system connected to the interactive voice response system and operable to calculate a permitted use time for user communications effectuated through the mobile station and with the called party; and
a home location register connected to the mobile switching center and the payment system and operating to store the prepaid subscription associated with the first telephone number;
wherein the mobile switching center pre-routes a call to the first telephone number to the home location register;
wherein the home location register recognizes that the pre-routing concerns the first telephone number prepaid subscription and queries the payment system to retrieve the second telephone number and the permitted use time for delivery to the mobile switching center; and
wherein the mobile switching center through connects the mobile station to the called party to establish a call connection, and monitors a duration of the established call connection against the calculated permitted use time.

13. The system as in claim 12 wherein the mobile switching center further detects that the monitored duration has as least met the calculated permitted use time and terminates the established call connection.

14. The system as in claim 13 wherein the payment system charges a fee for the utilized permitted use time against the identified prepaid method of payment instead of against the mobile station post-paid subscription.

15. The system as in claim 12 wherein the mobile switching center further detects a user termination of the established call connection prior to the expiration of the permitted use time and calculates an elapsed use time.

16. The system as in claim 15 wherein the payment system charges a fee for the calculated elapsed use time against the identified prepaid method of payment instead of against the mobile station post-paid subscription.

17. The system as in claim 12 wherein the first telephone number comprises a toll free telephone number.

18. A prepaid service system, comprising:
a mobile station having a post-paid subscription and operable to transceive user communications over a wireless cellular air interface; and
a supporting cellular communications network operating to calculate a permitted duration for prepaid user communications effectuated through the mobile station and monitor a call connection to ensure the call does not exceed the calculated permitted duration; and
a switching node connected to the base transceiver station and the means for calculating a permitted duration;
wherein the switching node operates to trigger, responsive to mobile station dialing of a certain prepaid subscription telephone number other than a destination telephone number for a prepaid call, an operation within the supporting cellular communications network to calculate the permitted use time for user communications effectuated through that mobile station.

19. The system as in claim 18 wherein the supporting cellular communications network further comprises:
a base transceiver station for communicating with the mobile station over the wireless cellular air interface.

20. The system as in claim 18 further including means within the supporting cellular communications network for collecting prepaid call payment information from the mobile station user.

21. The system as in claim 20 wherein the means for collecting comprises an interactive voice response system activated responsive to the mobile station call to the prepaid subscription telephone number and operating to query the user for the call payment information.

22. The system as in claim 20 wherein the means for calculating determines the permitted use time based on the collected call payment information.

23. The system as in claim 20 wherein charges for the call are applied against an account identified by the prepaid call payment information instead of against the mobile station post-paid subscription.

24. The system as in claim 18 wherein the prepaid subscription telephone number comprises a toll free number.
